(19) United States
(12) Patent Application Publication
(10) Pub. No.: US 2012/0200724 A1
(43) Pub. Date: Aug. 9, 2012

(54) Video Magnification Device

(76) Inventors: Umang Dua, Georgetown (CA); David Richard Bevers, Waterloo (CA)

(21) Appl. No.: 13/020,682

(22) Filed: Feb. 3, 2011

(51) Int. Cl. H04N 5/228

(52) U.S. Cl. 348/222.1; 348/E05.031

(57) ABSTRACT

A video magnification device allows a visually impaired user to read contents of a media. The device includes a video camera, and a driving unit. The video camera is positioned facing the media and is capable of capturing images of the media, or one or more portions thereof. The driving unit includes an input unit, a controller and an actuator assembly. The input unit is capable of being operated by the user for indicating a particular portion of the media for reading contents on the particular potion of the media. The controller is configured to process a signal generated by the input unit, and the actuator assembly is configured to move the video camera based on the processing of the signal. The movement of the video camera allows the user to read contents on the particular portion of the media, without physically moving the media.

### FIELD OF THE DISCLOSURE

The present disclosure generally relates to a video magnification device that allows a visually impaired user to read contents on a media, and more particularly, a video magnification device that allows the user to read the contents without physically moving the media.

### BACKGROUND OF THE DISCLOSURE

Video magnification devices are used by visually impaired users to read contents on a media, such as a document, a physical object, a sheet of paper, and the like. More specifically, these video magnification devices magnify the contents on the media, thereby allowing the users to easily read the contents.

A typical video magnification device includes a tray table, a video camera facing the tray table, and a display screen. The tray table may be adapted to hold the media thereon. The video camera may be capable of capturing contents on a portion of the media, and transmit output to the display screen. The display screen may be adapted to display the output of the video camera, thereby allowing the user to read the contents on the media.

However, in such conventional video magnification devices, the user is required to physically move the media on the tray table for adjusting the position of the media with respect to the video camera. More specifically, in such conventional video magnification devices, the video camera is only able to capture contents on a particular portion of the media, and therefore, the user is unable to view the contents on the rest of the portions of the media. Accordingly, the user has to physically move the media on the tray table so as to position the different portions of the media with respect to the video camera for reading the contents on these portions. This is cumbersome and tiring for the user, and may even cause wrist pains to the user.

The aforementioned problems intensify for elderly, who do not have good hand eye coordination, or for people who may be suffering from degenerative joint diseases, such as arthritis, or other similar disorders, which may incapacitate them from moving their hands freely. Also, such conventional video magnification devices are unable to improve quality of the output image captured by the video camera, thereby compelling the user to unnecessarily strain his/her eyes while reading the contents on the media.

### SUMMARY OF THE DISCLOSURE

In view of the foregoing disadvantages inherent in the prior-art, the general purpose of the present disclosure is to provide a video magnification device that is configured to include all advantages of the prior art and to overcome the drawbacks inherent in the prior art offering some added advantages.

To achieve the above objectives, in one aspect, the present disclosure provides a video magnification device that allows a visually impaired user to read contents on a media. The video magnification device includes a video camera positioned facing the media. The video camera may be capable of capturing images of the media, or one or more portions thereof. Further, the video magnification device includes a driving unit. The driving unit includes an input unit capable of being operated by the user. The user may operate the input unit for indicating a particular portion of the media for reading the contents on that portion of the media. The driving unit further includes a controller operatively coupled to the input unit. The controller may be configured to receive and process a signal generated by the input unit. The driving unit also includes an actuator assembly coupled to the controller and the video camera. The actuator assembly may be configured to move the video camera based on the processing of the signal generated by the input unit. The movement of the video camera actuated by the actuator assembly allows the video camera to capture an image of the particular portion of the media. This enables the user to read the contents on the particular portion of the media, without physically moving the media with respect to the video camera.

In a second aspect, the present disclosure provides a video magnification device that allows a visually impaired user to read contents on a media. The video magnification device includes a table for placing the media thereon. The table includes an actuator assembly capable of moving the table. Further, the video magnification device includes a video camera facing the table. The video camera may be capable of capturing images of the media, or one or more portions thereof. Further, the video magnification device includes a driving unit. The driving unit includes an input unit capable of being operated by the user. The user may operate the input unit for indicating a particular portion of the media for reading contents on that portion of the media. Further, the driving unit includes a controller operatively coupled to the input unit. The controller may be configured to process a signal generated by the input unit and send the processed signal to the actuator assembly of the table. The actuator assembly may be configured to move the table based on the receipt of the processed signal from the controller. The movement of the table actuated by the actuator assembly allows the video camera to capture an image of the particular portion of the media, thereby enabling the user to read contents on the particular portion of the media, without physically moving the media with respect to the table.

In another aspect, the present disclosure provides a method for enabling a visually impaired user to read contents on a media. The method includes positioning a video camera facing the media. The video camera may be capable of capturing images of the media, or one or more portions thereof. The method further includes providing an input unit to the user, the input unit capable of being operated by the user. The user may operate the input unit for indicating a particular portion of the media for reading contents on the portion of the media. The method may also include providing a controller for processing a signal generated by the input unit on being operated by the user. Furthermore, the method includes providing an actuator assembly for moving the video camera based on the processing of the signal by the controller. The movement of the video camera actuated by the actuator assembly allows the video camera to capture an image of the particular portion of the media, thereby enabling the user to read contents on the particular portion of the media, without physically moving the media with respect to the video camera.

### BRIEF DESCRIPTION OF THE DRAWINGS

The advantages and features of the present disclosure will become better understood with reference to the following detailed description and claims taken in conjunction with the accompanying drawing, in which:

FIG. 1 is a block diagram of a video magnification device, according to an embodiment of the present disclosure;

FIG. 2 is a side view of the video magnification device of FIG. 1, according to an embodiment of the present disclosure;

FIGS. 3-5 are side perspective views of the video magnification device of FIG. 2 in operation, according to an embodiment of the present disclosure;

FIG. 6 is a block diagram of a video magnification device, according to another embodiment of the present disclosure;

FIGS. 7-8 are perspective views of the video magnification device of FIG. 6 in operation, according to an embodiment of the present disclosure; and

FIGS. 9 and 10 are flow charts explaining a method for enabling a visually impaired user to read contents on a media, according to an embodiment of the present disclosure.

### DETAILED DESCRIPTION OF THE DISCLOSURE

The exemplary embodiments described herein detail for illustrative purposes are subject to many variations in structure and design. It should be emphasized, however, that the present disclosure is not limited to a particular video magnification device as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The use of terms “including,” “comprising,” or “having” and variations thereof herein is meant to encompass the items listed thereafter and equivalents thereof as well as additional items. Further, the terms, “a” and “an” herein do not denote a limitation of quantity, but rather denote the presence of at least one of the referenced item.

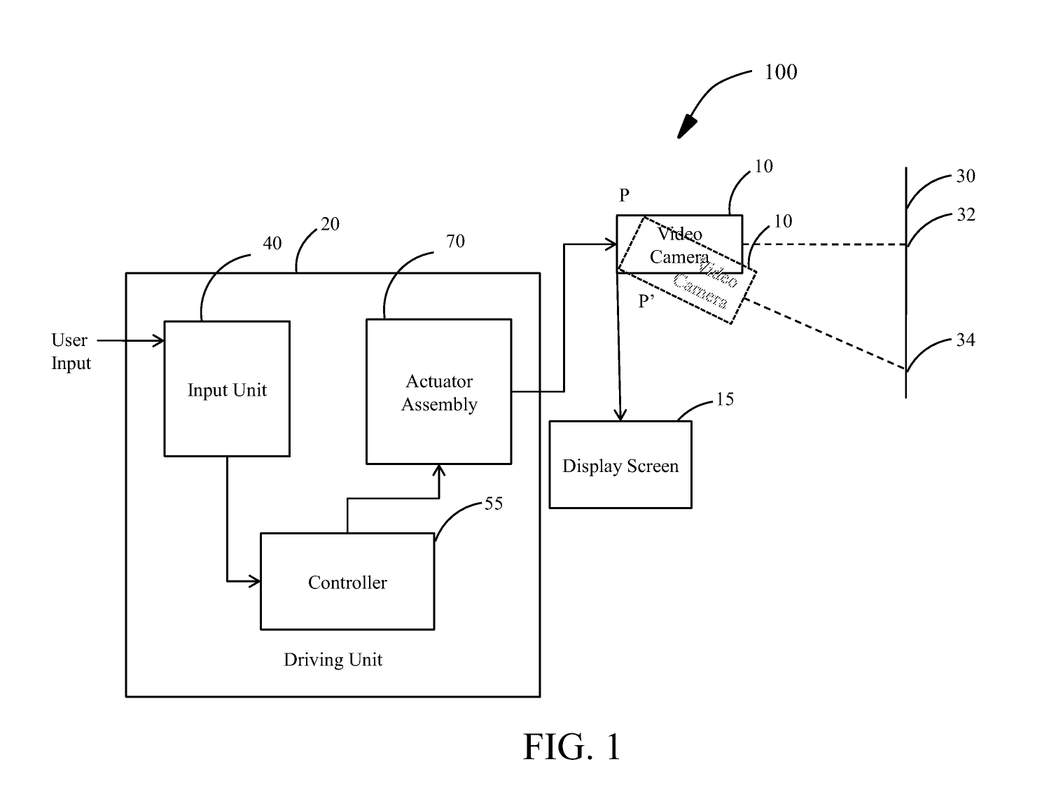

The present disclosure provides a video magnification device that allows a visually impaired user to read contents on a media. The term ‘media’ as mentioned herein refers to physical objects used for writing or displaying content. Suitable examples of such objects may include, but are not limited to, a whiteboard, a projection screen, and other similar objects that may be used in a typical class room environment for writing or projection purposes. The term ‘media’ as mentioned herein may also refer to any page or sheet of paper or cardboard on which contents may be written or printed or inscribed. Various embodiments of the video magnification device will now be explained in conjunction with FIGS. 1-10.

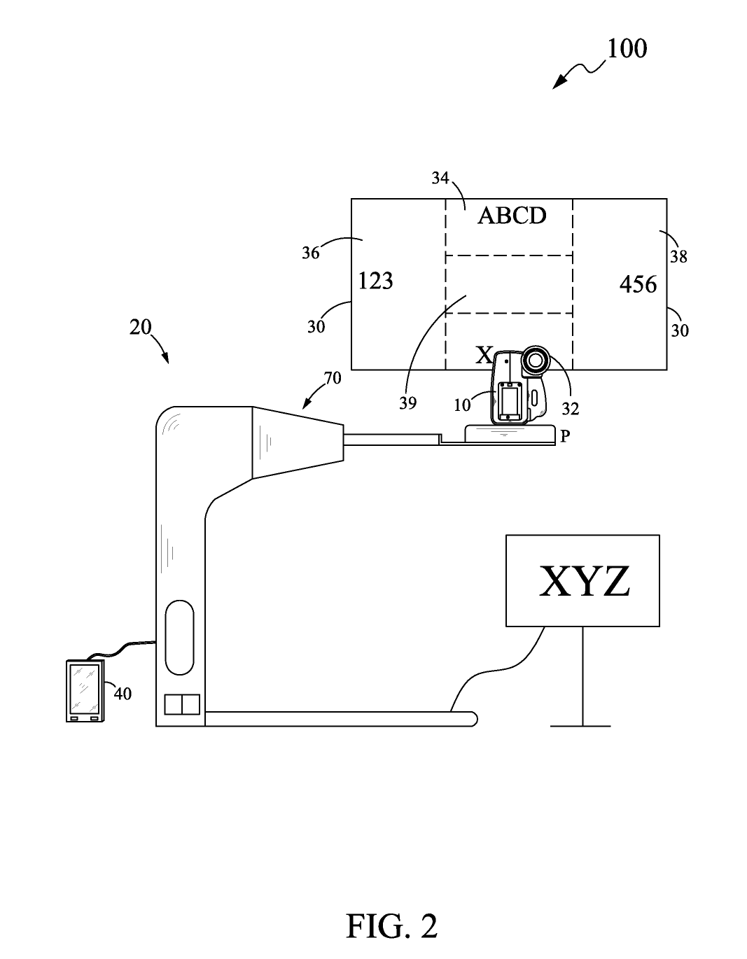

FIG. 1 depicts a block diagram of a video magnification device 100 that allows a visually impaired user (not shown) to read contents on a media 30, according to an embodiment of the present disclosure. The media 30 is shown (also refer FIG. 2) to be a whiteboard positioned at a distance from the video magnification device 100. The media 30 includes contents imprinted thereon.

The video magnification device 100 includes a video camera 10, a display screen 15 operatively coupled to the video camera 10, and a driving unit 20 operatively coupled to the video camera 10. The driving unit 20 is configured to move the video camera 10 from a position P to a position P′ based on directions given by the user. More specifically, the driving unit 20 includes an input unit 40, a controller 55 operatively coupled to the input unit 40, and an actuator assembly 70 operatively coupled to the controller 55 and the video camera 10. The operation and functioning of each component of the video magnification device 100 will be better understood by referring to FIGS. 2-5.

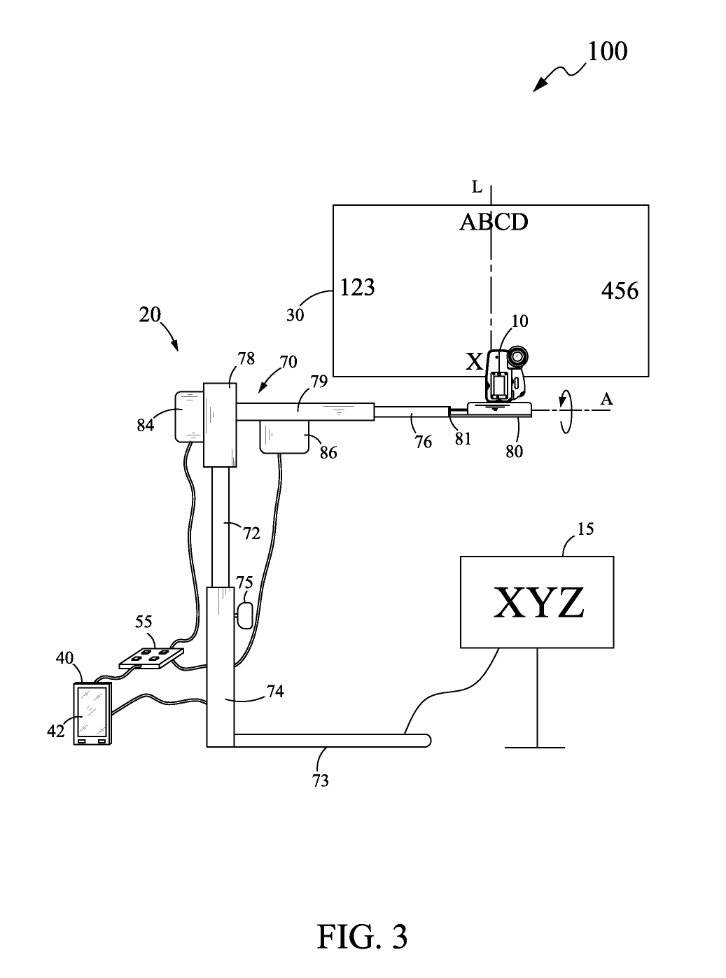

FIG. 2 depicts a side view of the video magnification device 100 of FIG. 1. Also, FIGS. 3-5 depict side perspective views of the video magnification device 100 in operation. As mentioned above, the media 30 is shown to be a whiteboard positioned at a distance from the video magnification device 100. However, it should be clearly understood that such positioning of the media 30 should not be construed as a limitation to the present disclosure. Accordingly, the video magnification device 100 of the present disclosure may equally apply to a case, where the media 30 is a sheet of paper, or a document, placed just below the video camera 10 rather than at a distance from the video camera 10 as particularly shown in the FIGS. 2-5. Further, the media 30 is shown to be divided into one or more portions 32, 34, 36, 38 and 39. However, it should be understood that the division of the media 30 into such 5 portions is done only for the purposes of explaining the invention, and should not in any way be construed as a limitation to the present disclosure. The media 30 is shown to include contents ‘ABCD’, ‘XYZ’, ‘123’ and ‘456’ written on respective portions of the media 30.

The video camera 10 is positioned facing the media 30. The video camera 10 may be capable of capturing images of the media 30, or the portions 32, 34, 36, 38 and 39 of the media 30. It should be understood that the images captured by the video camera 10 may be video images or still images. Furthermore, it will be obvious to a person skilled in the art that the video camera 10 may be required to zoom into the portions 32, 34, 36, 38 and 39 for capturing images (magnified images) of the portions 32, 34, 36, 38 and 39. As shown in FIG. 2, the video camera 10 is positioned at position ‘P’ so as to capture a video image of a portion 32 of the media 30. Accordingly, the video camera 10 is shown to be capturing contents ‘XYZ’ inscribed on the portion 32 of the media 30. The captured contents are being displayed on the display screen 15.

The video camera 10 as mentioned herein may be similar to conventional video cameras employed in typical video magnification devices. Preferably, the video camera 10 may be a high resolution video camera, which allows magnifications in the range of about 4× to about 40×. However, it should be clearly understood that such magnification range of the video camera 10 should not be construed as a limitation to the present disclosure. Further, the display screen 15 may be similar to conventional display screens employed in typical video magnification devices. Preferably, the display screen 15 may be a high resolution Liquid Crystal Display (LCD) screen, which may be adapted to be connected to the video camera 10 for displaying video images and still images captured by the video camera 10. In an embodiment of the present disclosure, the display screen 15 may also be a television screen, or a computer monitor, to which the video camera 10 may be operatively coupled.

The input unit 40 may be capable of being operated by the user. The user may operate the input unit 40 for indicating a particular portion (say portion 34) of the media 30 for reading contents on the particular portion (portion 34) at the display screen 15. It will be obvious to a person skilled in the art that the user may indicate the particular portion of the media 30 by looking into the contents being displayed at the display screen 15. The input unit 40 is similar to a touch screen based input unit. In an embodiment of the present disclosure, the input unit 40 may be similar to other typical input devices, such as a computer mouse, a joystick, a computer keyboard, or other known in the art input devices (sensor based or optical) that are capable of receiving inputs from the user with respect to the particular portion of the media 40 the user intends to see.

More specifically, the input unit 40 may be configured to receive a user input indicating the portion 34. The user input may be in form of a touch indicating the portion 34 on a screen 42 of the input unit 40. Alternatively, the user input may also be in form of a gesture indicating the portion 34. An example of such gesture may be a slide of a finger on the screen 42 towards the portion 34 of the media 30. Another example of such gesture may include sliding of one or more fingers towards each other on the screen 42. However, such examples of the gesture should not be construed as a limitation of the present disclosure.

In addition to receiving user input indicating the portion 34 of the media 30, the input unit 40 may also be configured to allow the user to control specific features of the video camera 10. For example, the input unit 40 may allow the user to control the zoom of the video camera 10, or may allow the user to capture still image of any portion of the portions 32, 34, 36, 38 and 39 of the media 30. In an embodiment of the present disclosure, such controlling of the zoom of the video camera 10 or capturing of still images may be done by the user using gestures or touches.

The input unit 40 may be further configured to generate a signal corresponding to the received user input. More specifically, the input unit 40 may be configured to generate an electronic signal corresponding to the received user input. The signal is representative of the indication of the user, when he/she operates the input unit 40. For example, if the user slides his/fingers towards the portion 34, the signal generated by the input unit 40 may be representative (say in strength or any similar parameter) of the portion 34. This signal may then be transmitted to the controller 55.

The controller 55, which is operatively coupled to the input unit 40, may be configured to understand the signal generated by the input unit 40. More specifically, the controller 55 may be configured to receive the signal and process the received signal to understand the indication of the user. Further, the controller 55 may be configured to transmit the processed signal to the actuator assembly 70. The processed signal may be an electronic signal and may include directions for the actuator assembly 70 to actuate in a particular way, so as to move the video camera 10 by a pre-calculated distance in a specific direction.

In an embodiment of the present disclosure, the controller 55 may additionally be configured to correct the signal generated by the input unit 40 before processing the signal. Such correction may be necessary to remove any redundant inputs that the user might have given while indicating the portion 34 on the input unit 40. Accordingly, such corrections may allow the controller 55 to determine the exactness of the portion 34, and accordingly give corresponding directions to the actuator assembly 70.

More specifically, the controller 55 may include a software based on a filtering algorithm for correcting the signal generated by the input unit 40. In an embodiment of the present disclosure, the filtering algorithm may detect the true intention of the user while operating the input unit 40 by evaluating deviation of the input given by the user. In such evaluation of the deviation, the algorithm may calculate the angular deviation when the user provides the input. For example, if the user slides his/her finger right at a 10 degree angle to the horizontal on the input unit 40, the algorithm will understand that the user probably intended to scroll towards the right and not upwards. The filtering algorithm may correspondingly set values such as, if the angle of slide is less than about 20 degrees to the horizontal then the movement is purely horizontal, or if the angle is less than about 20 degrees to the vertical then the movement is purely vertical and correct the signal generated by the input unit 40. However, it should be understood that such an example of the filtering algorithm should not be construed as a limitation to the present disclosure. Accordingly, other filtering algorithms typical employed to correct the touch screen based inputs may also be used. For example, in another embodiment of the present disclosure, a filtering algorithm based on scaling may be applied by the controller 55 on the signal generated by the input unit 40 for correction purposes. More specifically, the scaling algorithm may check for change in viewing area of the video camera 10 occurring on movement of the video camera 10 across the media 30, and accordingly may incorporate such changes to the signal generated when the user operates the input unit 40.

In another embodiment of the present disclosure, the controller 55 may also be configured to digitally combine still images captured by the video camera 10. Such digital combining of the still images may form an enhanced image of the media 30. The enhanced image may be used for variety of purposes, including performing an Optical Character Recognition (OCR) on the enhanced image. Such OCR performed on the enhanced image ensures that the video magnification device 100 is capable of performing an efficient and accurate text to speech of the contents on the media 30. The OCR capabilities may be provided in the video magnification device 100 using a software that may be embedded on the controller 55.

In another embodiment of the present disclosure, the controller 55 may be configured to perform Optical Character Recognition (OCR) on the images corresponding to the one or more portions of the media captured by the video camera 10. Further, the controller 55 may be configured to combine OCR output of the images for generating a final text output for speech.

The actuator assembly 70 may be configured to move the video camera 10 based on the processed signal received from the controller 55. The actuator assembly 70, various components thereof and operation of the components will be better understood by referring to FIGS. 3-5.

As shown in FIGS. 3-5, the actuator assembly 70 includes a vertical shaft 72. The vertical shaft 72 may be telescopically received in a supporting arm 74, which may extend from a base 73 of the video magnification device 100. The telescopic receiving of the vertical shaft 72 in the supporting arm 74 may allow for an adjustment of height ‘H’ of the video magnification device 100. Further, to ensure coupling of the vertical shaft 72 in the supporting arm 74, an adjustment knob 75 may be provided. The vertical shaft 72 and the supporting arm 74 may be composed of light weight and durable materials.

The actuator assembly 70 may further include a horizontal shaft 76 extending from a top end portion 78 of the vertical shaft 72. The horizontal shaft 76 may be substantially perpendicular to the vertical shaft 72. Further, the horizontal shaft 76 may be telescopically received in a supporting arm 79, which may extend from the top end portion 78 of the vertical shaft 72. The telescopic receiving of the horizontal shaft 76 in the supporting arm 79 may allow for adjusting length of the horizontal shaft 76. The horizontal shaft 76 and the supporting arm 79 may be composed of light weight and durable materials similar to those used for composing the vertical shaft 72.

Further, the actuator assembly 70 includes a base 80 attached at a free end portion 81 of the horizontal shaft 76. The base 80 is capable of supporting the video camera 10 thereon. Further, the base 80 may be capable of rotating about axis ‘A’ as shown in the FIG. 3. Such rotation of the base 80 is provided by the movement of the horizontal shaft 76. The base 80 may be in form of a flat plate made of robust and light weight materials. The video camera 10 may be removably secured to the base 80 by means of fasteners.

The actuator assembly 70 further includes a first motor 84 and a second motor 86. The first motor 84 may be operatively coupled to the horizontal shaft 76 and the controller 55. The first motor 84 may be similar to known in the art stepper motors, or other known in the art motors that may be capable of moving at a controlled rate with or without a feedback mechanism. Typical examples of such motors may include, but are not limited to, servo motors. Further, the first motor 84 may be positioned proximal to the top end portion 78 of the vertical shaft 72. However, such positioning of the first motor 84 should not be construed as a limitation to the present disclosure.

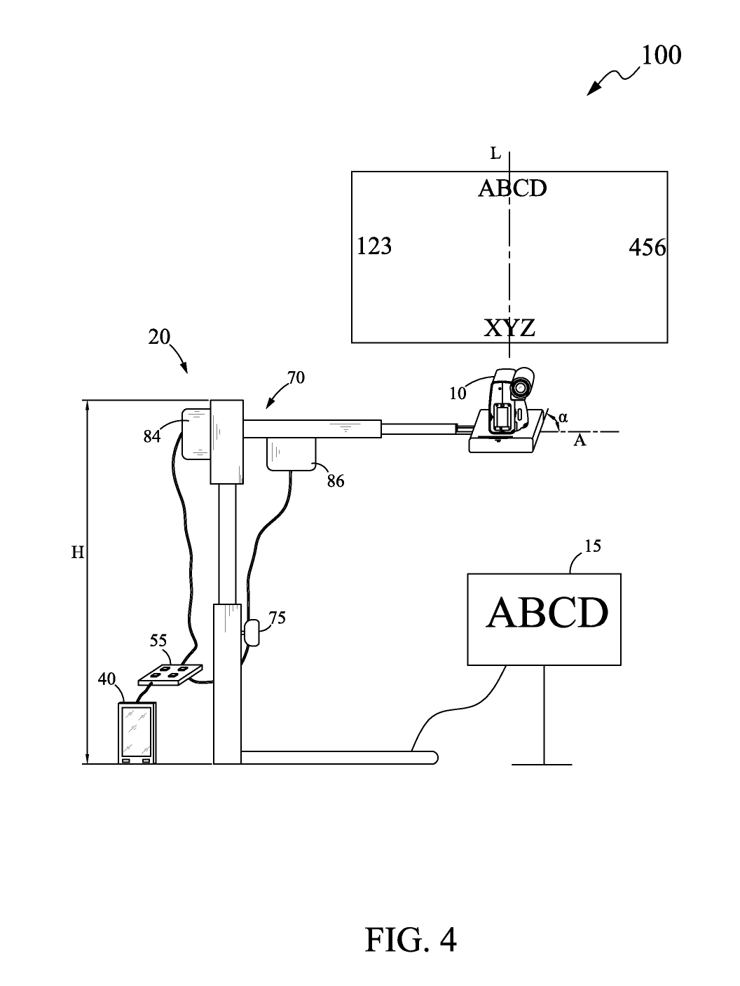

Further, the first motor 84 may be configured to rotate the horizontal shaft 76 based on the directions given by the controller 55. The rotation of the horizontal shaft 76 may rotate the base 80 allowing for tiling of the base 80 about its axis of rotation ‘A’. This allows the video camera 10 to traverse the media 30, and more specifically, traverse the media 30 along the longitudinal axis ‘L’ as shown in FIG. 3. The tilting of the base 80 based on the actuation by the first motor 84 is depicted in FIG. 4. FIG. 4 depicts the base 80 tilting at an angle a with respect to the axis ‘A’. The tilting of the base 80, therefore, allows the video camera 10 to capture the image of the portion 34 of the media 30, which may then be displayed to the user on the display screen 15. Accordingly, as shown in FIG. 4, the tilting of the base 80 allows the video camera 10 to capture and display the contents ‘ABCD’ on the display screen 15.

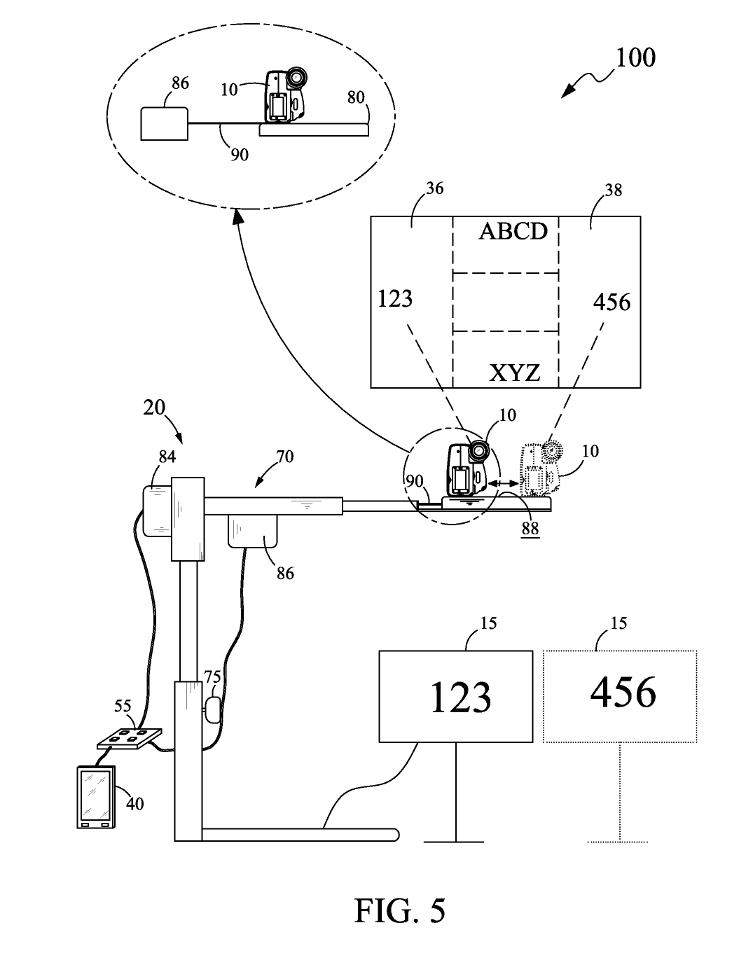

The second motor 86 may be operatively coupled to the video camera 10 to move the video camera 10 on the base 80. The second motor 86 may be similar to known in the art linear motors. However, other known in the art motors, such as servo motors and stepper motors may also be equally applied. The second motor 86 may be positioned on the supporting arm 79. However, the positioning of the second motor 86 as shown in FIG. 5 should not be construed as a limitation to the present disclosure. Accordingly, in an embodiment of the present disclosure, the second motor 86 may be directly positioned below the video camera 10 to actuate movement thereof. The operative coupling of the second motor 86 to the base 80 allows retracting of the video camera 10 across surface 88 of the base 80 as shown in FIG. 5. This allows the video camera 10 to traverse the media 30 across horizontal axis ‘H’ of the media 30. Accordingly, the video camera 10 may be capable of capturing images of portions 36 and 38 of the media 30 and displaying the captured images on the display screen 15 for the user. The specific mechanism of retracting of the video camera 10 across the surface 88 of the base 80 is shown in FIG. 5.

As shown in FIG. 5, the actuator assembly 70 may additionally include a cable 90. The cable 90 may be operatively connected to the second motor 86 and the video camera 10. More specifically, a free end of the cable 90 may be coupled to the second motor 86 and the opposite free end may be coupled to the video camera 10. The cable 90 may be adapted to pull/push the video camera 10 across the surface 88 of the base 80 based on the actuation of the second motor 86. It will be obvious to a person skilled in the art that such actuation mechanism is similar to known in the art gear driven motor systems. However, it should be clearly understood that such mechanism of retracting the video camera 10 should not be construed as a limitation to the present disclosure. Accordingly, other mechanisms, such as a belt driven system, or other similar mechanisms may also be used instead of such gear driven system.

The operative coupling of various components of the video magnification device 100, as described above, may be provided using both wired and wireless means. For wireless operative coupling, standard wireless data transmission protocols, such as Bluetooth, and other wireless exchange protocols may be used. The wired operative coupling may be through conventional known in the art wires.

In use, the video magnification device 100 allows a visually impaired user to read contents on a media 30. To operate the video magnification device 100, the user may first adjust height of the video magnification device 100 so as the video camera 10 is capable of capturing images of the media 30, or portions thereof. The user may adjust the video magnification device 100 by operating the adjustment knob 75. Thereafter, the user is required to operate the input unit 40 for giving directions to the video camera 10 regarding the portion of the media 30 the user intends to view. The user may provide the input by either touching a portion of the screen 42 of the input unit 40, or by sliding fingers across surface of the screen 42, or providing any particular gesture as an input to the input unit 40. Further, the user may also be capable of controlling operation of the video camera 10. For example, the user may be able to control the zoom of the video camera 10 by providing specific gesture based input on the screen 42. Once, the user operates the input unit 40, the controller 55 receives a corresponding signal from the input unit 40. On receipt of the signal, the controller 55 may also process the signal and send electrical signals to the first motor 84 and second motor 86. The electrical signals may guide the first motor 84 and the second motor 86 to actuate by a particular amount, so as to move the video camera 10 supported on the base 80 to longitudinally or horizontally traverse the media 30. This allows the user to capture images of various portions of the media 30, without actually moving the media 30 with respect to the video camera 10. Further, this may also allow the user to follow the contents on the media 30 on a real time basis.

Additionally, the user may also be able to do a text to speech of the contents of the media 30. Such text to speech may be done by generation of enhanced image of the media 30 by combining images of various constituent portions of the media 30, and performing an OCR of the enhanced image.

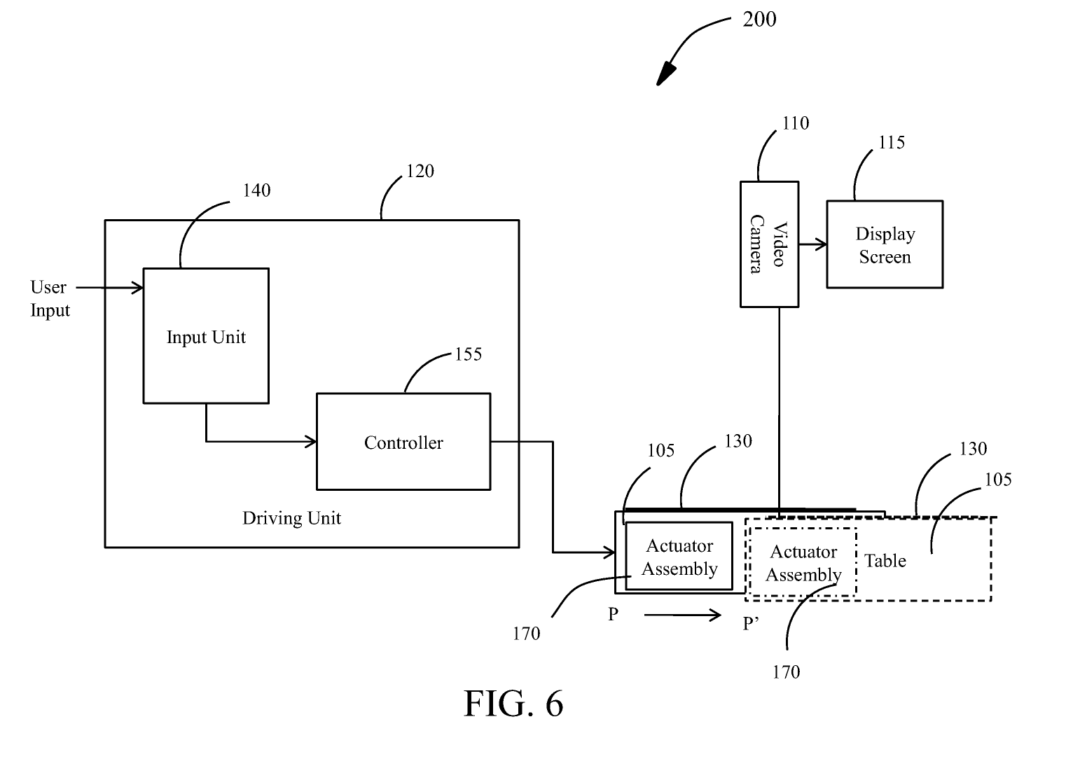

Now referring to FIGS. 6-8, there is shown a block diagram of a video magnification device 200 that allows a visually impaired user (not shown) to read contents on a media 130, according to another embodiment of the present disclosure. The media 130 is shown to be a sheet of paper, which may include contents imprinted thereon.

As shown in the FIGS. 6-8, the video magnification device 200 includes a table 105 for placing the media 130 thereon. The media 30 is shown to be divided into one or more portions 132, 134, 136, and 138. However, it should be understood that the division of the media 130 into 4 portions is done only for the purposes of explaining the invention, and should not in any way be construed as a limitation to the present disclosure. Further, the media 130 is shown to include contents ‘ABCD’ and ‘XYZ’, written on respective portions of the media 130. It should be understood that the table 105 may include one or more fasteners to clasp the media 130, when placed on the table 105. Further, the table 105 may include an actuator assembly 170 for moving the table 105 from a position P to P′ based on the directions given by the user.

In an embodiment of the present disclosure, the table 105 includes an x-y positioning table. It will be obvious to a person skilled in the art that such x-y positioning tables are commonly employed in manufacturing assemblies for variety of industrial operations. Usually, such tables include a moveable platform resting on a base. The platform may be adapted to be moved through a particular distance in either of two horizontal directions, referred to as ‘X-direction’ and ‘Y-direction’. Usually, the motion of the platform is by a pre-set amount and at a pre-set rate, and may be facilitated by a screw based system or a belt drive. The motion of the x-y positioning table is accomplished by a plurality of motors, specifically stepping motors, adapted to move at particular distances and particular rates. Further, such x-y positioning table usually includes one or more software, which allow for deciding the amount of movement of the platform and accordingly control the motion of the platform. However, it should be clearly understood that such implementation of the x-y positioning table should not be construed as a limitation to the present disclosure. Accordingly, the table 105 may be a table specifically retrofitted with an actuator assembly 170 including one or more motors and a guiding mechanism for moving the table by specific amounts and specific rates.

Further, the video magnification device 200 includes a video camera 110. The video camera 110 is positioned facing the table 105. More specifically, the video camera 110 may be positioned above the table 105. Further, the video camera 110 is capable of capturing images of the media 130, or the portions 132, 134, 136 and 138 of the media 130. The video magnification device 100 may also include a display screen 115 operatively coupled to the video camera 110 for displaying output of the video camera 110 thereon. It should be understood that the inherent functioning and the capabilities of the video camera 110 and the display screen 115 are similar to the video camera 10 and display screen 15 described above, and therefore, detailing of the video camera 110 and the display screen 115 may be avoided for the sake of brevity of the patent application.

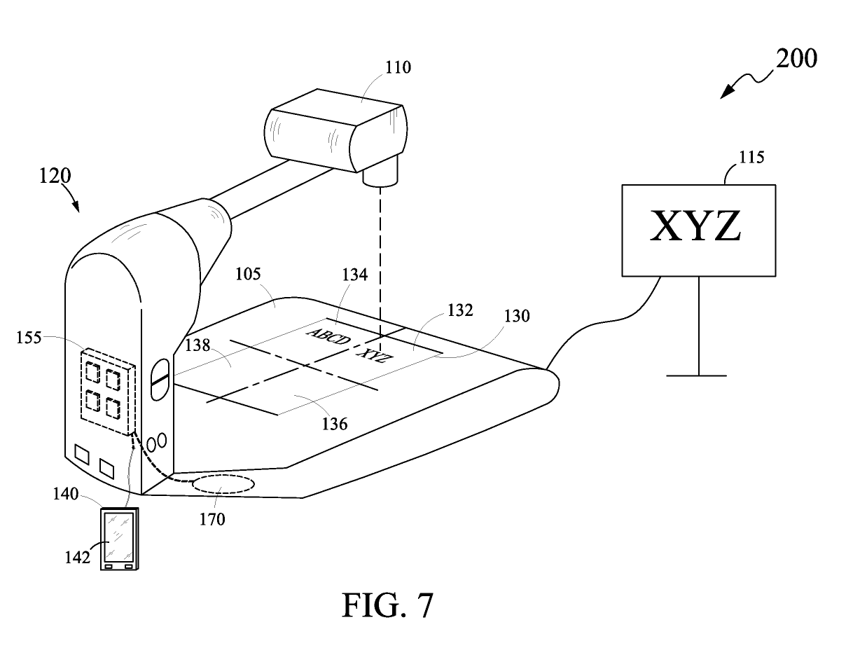

As shown in FIGS. 6-7, the video camera 110 is shown to be capturing a video image of portion 132 of the media 130. Accordingly, the video camera 110 is shown to be capturing contents ‘XYZ’ inscribed on the media 130 and the same are being displayed on the display screen 115 for the user.

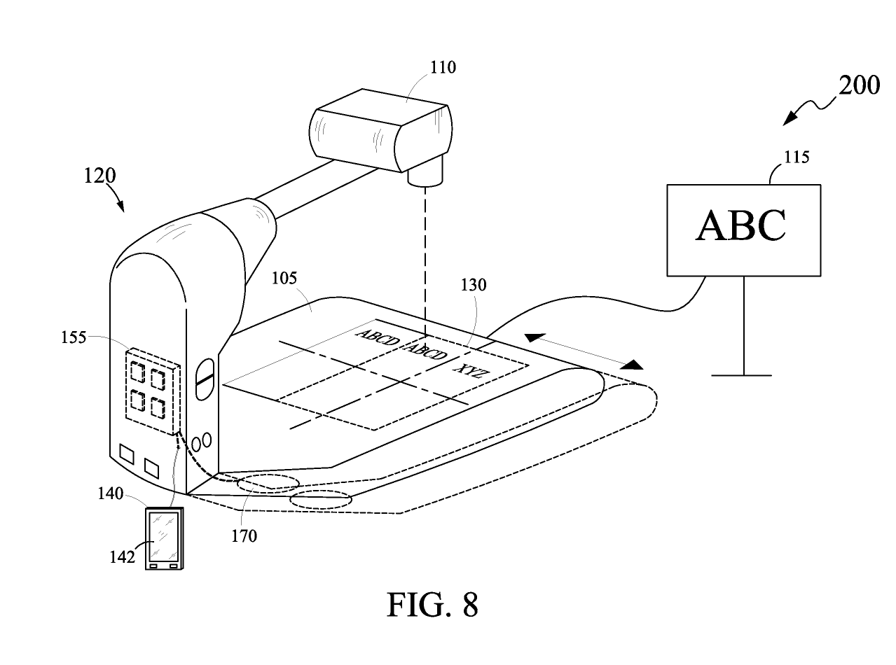

The video magnification device 200 further includes a driving unit 120 operatively coupled to the table 105. More specifically, the driving unit 120 includes an input unit 140 capable of being operated by the user. The user operates the input unit 140 for indicating a portion (say portion 134) of the media 130 for reading contents on the portion 134 of the media 130. Even more specifically, the input unit 140 is configured to receive a user input indicating the portion 134, and generate the signal corresponding to the received user input. Further, it should be understood that the inherent functioning and the capabilities of the input unit 140 are similar to the input unit 40 described above, and therefore detailing of the input unit 140 may be avoided for the sake of brevity of the patent application. The input unit 140 is shown to be a touch screen based input unit in FIGS. 7-8.

Further, the driving unit 120 may include a controller 155 operatively coupled to the input unit 140 and the table 105. The controller 155 may be configured to receive the signal generated by the input unit 140, process the signal, and send the processed signal to the actuator assembly 170 of the table 105. Further, it should be understood that the inherent functioning and the capabilities of the controller 155 are similar to the controller 55 described above, and therefore detailing of the controller 155 may be avoided for the sake of brevity of the patent application.

The actuator assembly 170 is configured to move the table 105 based on the receipt of the processed signal from the controller 155. The movement of the table 105 actuated by the actuator assembly 170 allows the video camera 110 to capture an image of the portion 134 of the media 130, thereby enabling the user to read contents on the portion 134 of the media, without physically moving the media 130 with respect to the table 105. Accordingly, as shown in FIG. 8, the user is able to read the contents ‘ABCD’ on the media 130.

The operation of the video magnification device 200 is similar to the operation of the video magnification device 100. To operate the video magnification device 200, the user is required to first place the media 130 on the table 105. Thereafter, the user may adjust the video magnification device 200 so as the video camera 110 is capable of capturing images of the media 130. Thereafter, the user is required to operate the input unit 140 for giving directions to the video camera 110 regarding the portion of the media 130 the user intends to view. The user may provide the input by either touching a portion of the screen 142 of the input unit 140, or by sliding fingers across surface of the screen 142, or providing any particular gesture as an input to the input unit 140. Further, the user may also be capable of controlling operation of the video camera 110. For example, the user may be able to control the zoom of the video camera 110 by providing specific gesture based input on the screen 142. Once, the user operates the input unit 140, the controller 155 receives a corresponding signal. On receipt of the signal, the controller 155 may also process the signal and send electrical signals to the actuator assembly 170 of the table 105. The electrical signals may guide the actuator assembly 170 to actuate, by a particular amount, the movement of the table 105. The movement of the table 105 allows the video camera 110 to capture an image of the portions 132, 134, 136, and 138 of the media 130, thereby enabling the user to read contents on the portions 132, 134, 136, and 138 of the media, without physically moving the media 130 with respect to the table 105.

Additionally, the user may also be able to do a text to speech of the contents of the media 130. Such text to speech may be done by generation of enhanced image of the media 130 by combining images of various constituent portions of the media 130, and performing an OCR of the enhanced image. Alternatively, the text to speech may also be done by performing OCR on the various constituent portions 132, 134, 136, 138, and 139 of the media 130, and combining the OCR output to generate the final text output for speech.

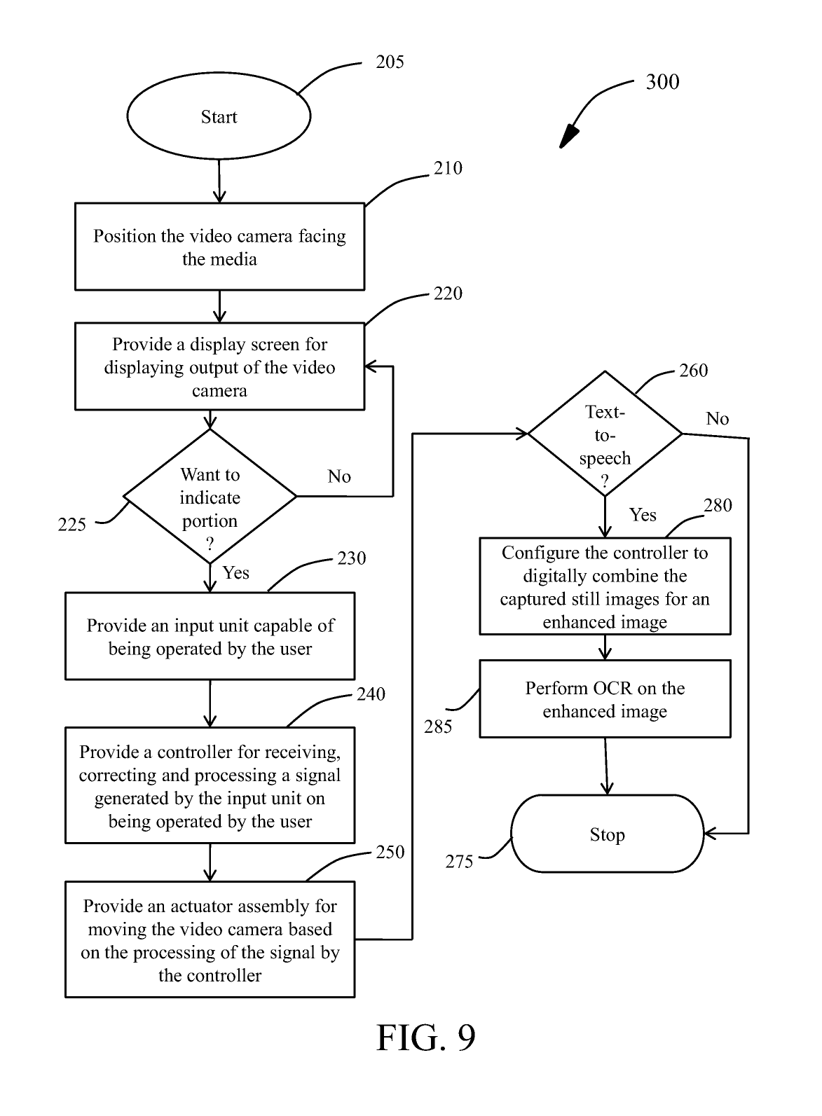

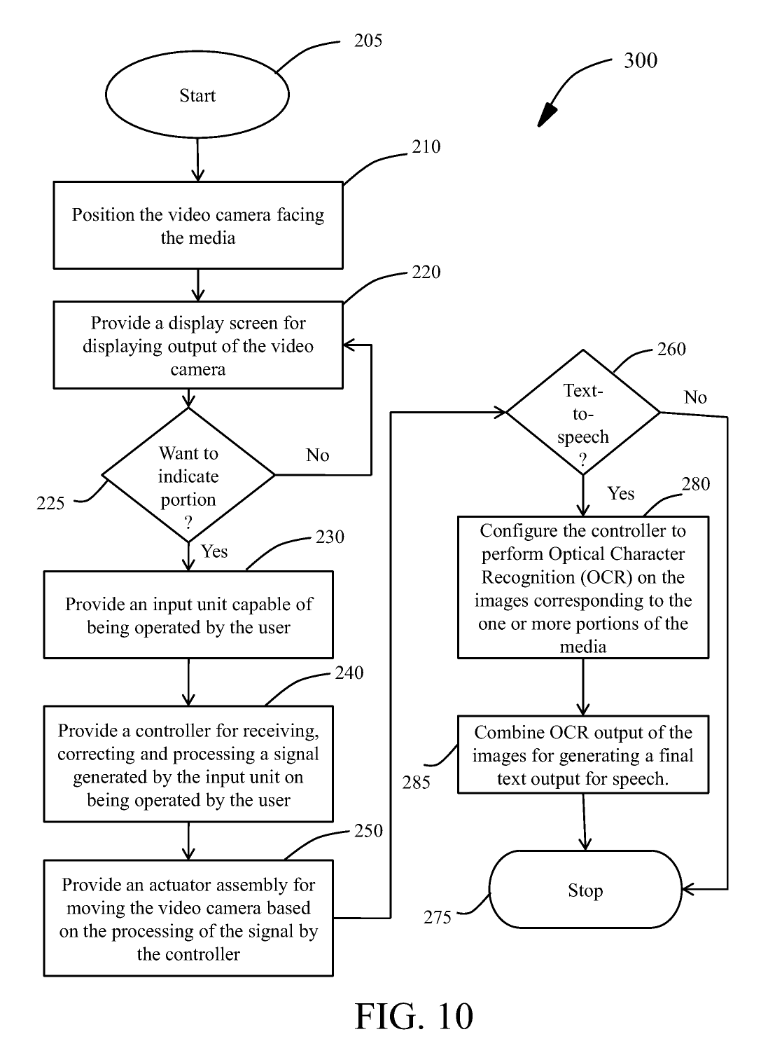

In another aspect, the present disclosure provides a method for enabling a visually impaired user to read contents on a media, according to an embodiment of the present disclosure. The method will now be explained with respect to flow chart of FIGS. 9-10.

As shown in FIG. 9, method 300 for enabling a visually impaired user to read contents on a media. The method 300 starts at 205. The method 300 includes positioning a video camera facing the media, at step 210. The video camera is similar to the video camera 10, and is capable of capturing still and video images of the media, or one or more portions thereof. After the positioning of the video camera, the method includes providing a display screen configured to display the images captured by the video camera, at step 220. The display screen is similar to the display screen 15 as described above. Thereafter, the flow moves to decision box 225. At decision box 225, it is determined whether the user intends to indicate a particular portion of the media for reading contents on the portion of the media. If yes, the flow moves to 230, where the method 300 includes providing an input unit capable of being operated by the user. Thereafter, the method 300 further includes providing a controller, similar to controller 55, for receiving, correcting and processing a signal generated by the input unit on being operated by the user, at step 240. After, the processing of the signal by the controller at step 240, the flow may move to step 250. At step 250, the method 300 may include providing an actuator assembly, similar to actuator assembly 70, for moving the video camera based on the processing of the signal by the controller. The movement of the video camera actuated by the actuator assembly at step 250 allows the video camera to capture an image of the particular portion of the media, thereby enabling the user to read contents on the particular portion of the media, without physically moving the media with respect to the video camera.

Thereafter, the flow moves to decision box 260. At decision box 260, the user may be asked to provide input regarding performing a “text-to-speech' of the contents of the media. If the user does not intend to perform a ‘text to speech’, the method 300 ends at step 275. If the user intends to perform a ‘text to speech’, the method 300 moves to step 280. At step 280, the controller is configured to digitally combine the captured still images of the media for generating an enhanced image of the media. This enhanced image is then OCR by the controller to produce the ‘text to speech’, at step 285. Alternatively, referring to FIG. 10, the controller may perform OCR on the images of the one or more portions of the media, at step 280, and combine the resulting OCR output to produce the ‘text to speech’, at step 285. Thereafter, the method 300 ends at 275.

Another embodiment of the present disclosure provides a method for enabling a visually impaired user to read contents on a media. The method includes providing a table for placing the media thereon, and positioning a video camera facing the table. The video camera capable of capturing images of the media, or one or more portions thereof. Further, the method includes providing an input unit to the user, the user capable of operating the input unit for indicating a particular portion of the media for reading contents on the particular portion of the media. Further, the method includes providing a controller configured to process a signal generated by the input unit, and send the processed signal to an actuator assembly of the table. The movement of the table actuated by the actuator assembly allows the video camera to capture an image of the particular portion of the media, thereby enabling the user to read contents on the particular portion of the media, without physically moving the media with respect to the table.

The present disclosure provides a video magnification device, such as the video magnification device 100 and 200, which allows a visually impaired user to read contents of a media without physically moving the media. Accordingly, the video magnification device is easily operated by a user, and specifically by elderly users and people who may be suffering from degenerative joint diseases, such as arthritis. Further, the video magnification device is specifically useful in class room environments, as it allows the user to follow the contents written or presented on a white board, or a projection screen in a real time basis. Furthermore, the video magnification device is capable of improving the quality of the output image captured by the device, thereby avoiding unnecessary strain on the user. Lastly, the video magnification device is portable, capable of being disassembled and easily stored.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. (It is understood that various omission and substitutions of equivalents are contemplated as circumstance may suggest or render expedient, but such are intended to cover the application or implementation without departing from the spirit or scope of the claims of the present disclosure).

What is claimed is:

1. A video magnification device that allows a visually impaired user to read contents on a media, the video magnification device comprising:
a video camera positioned facing the media, the video camera capable of capturing images of the media, or of one or more portions of the media; and
a driving unit comprising,
an input unit capable of being operated by the user, the user operating the input unit for indicating a particular portion of the media for reading contents on the particular portion of the media,
a controller operatively coupled to the input unit, the controller configured to receive and process a signal generated by the input unit, and
an actuator assembly coupled to the controller and the video camera, the actuator assembly configured to move the video camera based on the processing of the signal generated by the input unit,
wherein movement of the video camera actuated by the actuator assembly allows the video camera to capture an image of the particular portion of the media, thereby enabling the user to read the contents on the particular portion of the media, without physically moving the media with respect to the video camera.

2. The video magnification device of claim 1 further comprising a display screen configured to display the images captured by the video camera.

3. The video magnification device of claim 1, wherein the input unit is configured to,
receive a user input indicating the particular portion, and
generate the signal corresponding to the received user input.

4. The video magnification device of claim 1, wherein the input unit comprises a touch screen based input unit.

5. The video magnification device of claim 1, wherein the input unit comprises at least one of a computer mouse, a joystick, and a keyboard.

6. The video magnification device of claim 1, wherein the actuator assembly comprises:
a vertical shaft;
a horizontal shaft extending from a top end portion of the vertical shaft, the horizontal shaft substantially perpendicular to the vertical shaft;
a base attached at a free end portion of the horizontal shaft, the base capable of supporting the video camera thereon;
a first motor operatively coupled to the horizontal shaft and the controller, the first motor capable of tilting the base about the free end portion, wherein tilting the base about the free end portion allows the video camera to traverse the media; and
a second motor operatively coupled to the video camera and the controller, the second motor capable of retracting the video camera about a surface of the base, wherein retracting the video camera across the surface of the base the point of support allows the video camera to horizontally traverse the media.

7. The video magnification device of claim 6, wherein the actuator assembly further comprises a cable operatively coupled to the second motor and the video camera, the cable capable of retracting the video camera across the surface of the base.

8. The video magnification device of claim 1, wherein the controller comprises a filtering algorithm for correcting the signal generated by the input unit.

9. The video magnification device of claim 1, wherein the controller is further configured to digitally combine the images corresponding to one or more portions of the media for forming an enhanced image of the media, the enhanced image allowing an Optical Character Recognition (OCR) to be performed thereon.

10. The video magnification device of claim 1, wherein the controller is further configured to perform Optical Character Recognition (OCR) on the images corresponding to the one or more portions of the media.

11. The video magnification device of claim 10, wherein the controller is further configured to combine OCR output of the images for generating a final text output for speech.

12. The video magnification device of claim 1, wherein the images are at least one of video images and still images.

13. A video magnification device that allows a visually impaired user to read contents on a media, the video magnification device comprising:
a table for placing the media thereon, the table comprising an actuator assembly capable of moving the table;
a video camera facing the table, the video camera capable of capturing images of the media, or of one or more portions of the media; and
a driving unit comprising:
an input unit capable of being operated by the user, wherein the user operates the input unit for indicating a particular portion of the media for reading contents on the particular portion of the media, and
a controller operatively coupled to the input unit and the table, the controller configured to,
process a signal generated by the input unit, and
send the processed signal to an actuator assembly of the table, wherein the actuator assembly is configured to move the table based on the receipt of the processed signal from the controller,
wherein movement of the table actuated by the actuator assembly allows the video camera to capture an image of the particular portion of the media, thereby enabling the user to read contents on the particular portion of the media, without physically moving the media with respect to the table.

14. The video magnification device of claim 13, wherein the table comprises an x-y positioning table.

15. The video magnification device of claim 13, wherein the input unit is configured to,
receive a user input indicating the particular portion, and
generate the signal corresponding to the received user input.

16. The video magnification device of claim 13, wherein the input unit comprises a touch screen based input unit.

17. The video magnification device of claim 13, wherein the controller is further configured to digitally combine the images corresponding to one or more portions of the media for forming an enhanced image of the media, the enhanced image allowing an Optical Character Recognition (OCR) to be performed thereon.

18. A method for enabling a visually impaired user to read contents on a media, the method comprising:
positioning a video camera facing the media, the video camera capable of capturing images of the media, or one or more portions thereof;
providing an input unit capable of being operated by the user, wherein the user operates the input unit for indicating a particular portion of the media for reading contents on the portion of the media;
providing a controller for receiving and processing a signal generated by the input unit on being operated by the user; and
providing an actuator assembly for moving the video camera based on the processing of the signal by the controller,
wherein movement of the video camera actuated by the actuator assembly allows the video camera to capture an image of the particular portion of the media, thereby enabling the user to read contents on the particular portion of the media, without physically moving the media with respect to the video camera.

19. The method of claim 18 further comprising configuring the controller to digitally combine the captured images for generating an enhanced image of the media,
wherein the enhanced image allows a Optical Character Recognition (OCR) to be performed thereon.

20. The method of claim 18 further comprising configuring the controller to,
perform Optical Character Recognition (OCR) on the images corresponding to the one or more portions of the media, and
combine OCR output of the images for generating a final text output for speech.
